(19) United States
(12) Patent Application Publication
(10) Pub. No.: US 2010/0168338 A1
(43) Pub. Date: Jul. 1, 2010

(54) METHOD FOR PREPARING A POLYMERIC MATERIAL INCLUDING A MULTIBLOCK COPOLYMER PREPARED BY CONTROLLED FREE-RADICAL POLYMERISATION

(76) Inventor: Olivier Guerret, La Tour De Salvagny (FR)

Correspondence Address: ARKEMA INC.;PATENT DEPARTMENT - 26TH FLOOR, 2000 MARKET STREET, PHILADELPHIA, PA, 19103-3222, US

(21) Appl. No.: 12/063,063

(22) PCT Filed: Aug. 8, 2006
(86) PCT No.: PCT/FR06/50791

§ 371 Date: Feb. 6, 2008

(30) Foreign Application Priority Data
Aug. 9, 2005 (FR) 0508469

(51) Int. Cl. C08F 293/00

(52) U.S. Cl. 525/204; 525/228; 525/209; 525/212

(57) ABSTRACT

A method for preparing a polymeric material including a multiblock copolymer with n blocks, where n is an integer no lower than 2, which method comprises at least one cycle of steps including (a) a step of synthesising a block by performing controlled free-radical polymerisation of one or more free-radical polymerisable monomers, and (b) a step of polymerising the monomers that were not converted during step (a) into a polymer having a number-average molecular weight lower than the number-average molecular weight of said block, wherein said cycle of steps is carried out at least for the (n−1) first blocks.

### TECHNICAL FIELD

The present invention relates to a method for preparing a polymeric material comprising a multiblock copolymer prepared by controlled free-radical polymerization.

The present invention also relates to a nanostructuring and nanostructured polymeric material that can be used as a thermoplastic or as a reinforcing additive or rheological additive of host matrices: it being possible for this material to find its application in the manufacture of transparent parts having improved mechanical properties.

The general field of the invention is therefore that of polymeric materials, and more particularly nano-structured polymeric materials.

Nanostructured polymeric materials are materials organized into domains, the dimensions of which are less than 100 nm. Such materials have the advantage of remaining transparent and, when said material is introduced into a host matrix, of not disturbing the properties thereof.

### PRIOR ART

Nanostructured domains can be produced by particles of polymers dispersed in another polymer constituting a host matrix, said particles having a size defining the size of the domains. These particles are obtained by an emulsion polymerization method. However, it so happens that it is difficult to obtain, at this time on an industrial scale, by this method, particles of such sizes due to the instability of the emulsions. Furthermore, the particle distribution is greatly conditioned by the blending step, which, if it is not carried out meticulously, runs the risk of hindering the final physicochemical properties.

In order to obtain nanometric distributions of a polymer in a host matrix, some authors have taken advantage of the concept of self-organization of the block copolymers. Thus, if an A-B block copolymer is blended with a polymer C compatible with the block B, the resulting blend becomes organized due to the repulsions between the block A and the blend of the block B with the block C. These repulsions take place on the scale of the polymer chains, which results in organizations on the scale of a few tens of nanometers.

The advantage of this approach for manufacturing nanostructured materials comes from the fact that the blend becomes organized in a thermodynamically stable manner, which makes the manufacture much less dependent on the blending process.

Block copolymers are generally obtained by “living” polymerization techniques, i.e. techniques where the termination reactions tend to be limited, in such a way that the polymer chains continue to grow as long as monomers remain available.

Two major paths of living polymerization synthesis predominate:
anionic polymerization, dedicated to the synthesis of copolymers from ethylenic monomers comprising one or more electron-withdrawing substituents, such as a copolymer of the polystyrene-butadiene type;
cationic polymerization, dedicated to the synthesis of copolymers from ethylenic monomers comprising one or more electron-donating substituents, such as copolymers of the polyether type.

However, these two paths of synthesis are dependent, as emerges from the above paragraphs, on the nature of the monomers and therefore limit the variety of the monomers that can be used in the blocks of the copolymers and therefore the fields of application of these paths of synthesis for manufacturing nanostructured materials and, subsequently, of the materials obtained.

For about twenty years, scientists have worked to broaden the possibilities for synthesizing block copolymers by developing a new path of synthesis, which is free-radical polymerization, more particularly controlled free-radical polymerization (known under the abbreviation CRP).

Several types of controlled free-radical polymerization exist according to the nature of the control agent used:
the type using nitroxides as control agent and, for example, alkoxyamines as initiator, known under the abbreviation SFRP (stable free-radical polymerization);
the type using metal complexes as control agent and, for example, halogenated compounds as initiator, known under the abbreviation ATRP (atom transfer radical polymerization);
the type using sulfur compounds as control agent (also performing the role of initiators), such as dithioesters, trithiocarbamates, xanthates or dithiocarbamates, known under the abbreviation RAFT (reversible addition fragmentation transfer).

The role of the control agent is to slow down the biradical termination reactions, so as to promote chain growth by addition on the free monomer. However, when one attempts to push these polymerizations toward high conversions, the termination reactions necessarily take place. By gradually decreasing the ratio between propagating chains and control agent, this considerably slows down the polymerization kinetics.

Thus, with the SFRP or ATRP technique, in order to go beyond a degree of conversion of 90%, it is generally necessary to wait more than 24 hours.

It thus readily emerges that controlled free-radical polymerization, although it allows the production of polymers of broader chemical nature compared with ionic polymerizations, has serious limitations for the synthesis of block copolymers in the industrial environment.

In order to overcome these limitations, it is, for example, possible to stop the polymerization of a block at a selected degree of conversion and to eliminate, for example by evaporation, the residual amount of monomers, before the synthesis of the subsequent block that must attach to the preceding block. The step of eliminating the residual amount of monomers is a laborious step, since it is carried out in a viscous medium and as a result requires resorting to either expensive industrial equipment (such as an extruder) or to distillation times that are completely unacceptable in the industrial environment.

In order to overcome the limitations mentioned above, it is also possible to envision carrying out the polymerization of the subsequent block in the presence of the monomers that were not converted in the preceding block and eliminating the residual monomers at the end of the synthesis of the block copolymer. However, this alternative generates pollution of the subsequent block with the monomers of the preceding block, which results in a subsequent block whose properties, in particular the physicochemical properties have been changed compared with a “pure” block, i.e. a block comprising no monomers other than those of which it must be formed. Thus, when it is desired to associate a first block (referred to as block A, comprising monomers M₁) having a low glass transition temperature (Tg₁) with a second block (referred to as block B, comprising monomers M₂) having a high glass transition temperature (Tg₂), the glass transition temperature of the second block is directed by Fox's law defined by the following equation:

1/Tg(B)=x(M₁)/Tg₁+x(M₂)/Tg₂

in which:
x(M₁) and x(M₂) represent, respectively, the fraction by volume of M₁ and the fraction by volume of M₂ with x(M₁)+x(M₂)=1;
Tg₁ corresponds to the glass transition temperature of the first block;
Tg₂ corresponds to the glass transition temperature of the second block.

It can thus be readily observed that the glass transition temperature of the second block is affected by the presence of monomers derived from the first block. It thus follows from this that there is a degradation of the physicochemical and mechanical properties compared with what one could expect from a pure diblock polymer.

Thus, the known methods for preparing block (or multiblock) copolymers by controlled free-radical polymerization all have one or more of the following drawbacks:
they require laborious processing steps for eliminating or reducing, between the steps of synthesizing each block, the residual monomers;
they result in pollution of the blocks with the monomers constituting the prior blocks, which generates a modification of the physicochemical and mechanical properties of the resulting multiblock copolymers compared with what one might expect with a pure multiblock copolymer.

The inventors therefore set themselves the objective of developing a method for preparing a polymeric material comprising a multiblock copolymer which does not have the drawbacks of the prior art methods mentioned above. They thus discovered, surprisingly, that by carrying out a specific step after the step of producing the blocks, it was possible to overcome the above-mentioned drawbacks.

### SUMMARY OF THE INVENTION

According to a first subject, the invention thus relates to a method for preparing a polymeric material comprising a multiblock copolymer comprising n blocks, where n is an integer greater than or equal to 2, said method comprising at least one cycle of steps comprising:
a) a step of synthesizing a block by controlled free-radical polymerization of one or more free-radical-polymerizable monomers;
b) a step of polymerizing the monomers that were not converted during step a) into a polymer having a number-average molecular weight lower than the number-average molecular weight of said block;
   wherein said cycle of steps is carried out at least for the first (n−1) blocks.

Advantageously, the cycle of steps is carried out for the n blocks.

Thus, by virtue of the polymerization step b), the monomers that were not converted during each step a) are converted into a polymer having a number-average molecular weight lower than the number-average molecular weight of said block, of chemical nature identical to said block. The polymer produced is thus compatible with the block previously produced.

The expression “polymer compatible with the block” is intended to mean a polymer capable of interacting with said block, so as to be miscible in said block.

Thus, one is free of the step of eliminating the residual monomers and of the risk of polluting the subsequent blocks. At the end of the method of the invention, a nanostructured or nanostructuring polymeric material having physicochemical and mechanical properties, such as the glass transition temperature, inherent to each block, that are not impaired compared with those of a pure block, is thus obtained.

This method also proves to be a method that is easy to implement and inexpensive and therefore very advantageous for use in the industrial environment.

In other words, the method of preparation of the invention comprises successively:
a step of preparing a first block from one or more monomers by controlled free-radical polymerization;
a step of polymerizing the monomers that were not converted during the preceding step, into a polymer of chemical nature identical to the first block but having a number-average molecular weight lower than the number-average molecular weight of the first block;
a step of introducing a second monomer or mixture of monomers, different than the monomer or mixture of monomers that was used to produce the first block;
a step of polymerizing the second monomer or mixture of monomers so as to form the second block;
a step of polymerizing the monomers that were not converted during the preceding step, into a polymer of chemical nature identical to the second block but having a number-average molecular weight lower than the number-average molecular weight of the second block, and so on, until the desired number of blocks for the copolymer, it being understood that the third, . . . , nth blocks may be of nature identical to or different than that of the first and second blocks.

Although the invention relates to a method for preparing a polymeric material comprising a multiblock copolymer, it applies most particularly to the preparation of a polymeric material comprising a copolymer comprising at least one block A and at least one block B.

The application therefore also relates to a method for preparing a polymeric material comprising a copolymer comprising at least one block A and at least one block B, said method comprising successively:
1) a step of polymerizing one or more free-radical-polymerizable monomers by controlled free-radical polymerization, so as to form block A;
2) a step of polymerizing the residual monomer(s) that was (were) not converted during step 1), so as to form a polymer of chemical nature identical to block A but having a number-average molecular weight lower than that of block A and, generally, having a polydispersity index higher than that of block A;
3) a step of adding to the medium resulting from the preceding steps 1) and 2) one or more free-radical-polymerizable monomers that are precursors of block B;
4) a step of polymerizing said monomer(s) that is (are) a precursor or precursors of block B by controlled free-radical polymerization, said block B being linked to block A by covalent bonding;
5) optionally, a step of polymerizing the residual monomer(s) that was (were) not converted during step 4), so as to form a polymer of chemical nature identical to block B but having a number-average molecular weight lower than that of block B and, generally, having a polydispersity index higher than that of block B.

It is understood that the invention applies not only to the synthesis of diblock copolymers, but also of triblock copolymers, or of multibranched copolymers, etc.

The synthesis of the blocks of the multiblock copolymers of the invention is carried out by controlled free-radical polymerization at a temperature suitable for the type of CRP selected (depending on whether it is SFRP, ATRP or RAFT) and for the type of monomers selected.

Advantageously, the free-radical polymerization technique used for each step a) and for steps 1) and 4) is SFRP polymerization preferably carried out in the presence of at least one alkoxyamine, wherein this type of compound performs both the role of initiating agent and the role of control agent.

Alkoxyamines advantageously used according to the invention can be chosen from the monoalkoxyamines of formula (I):

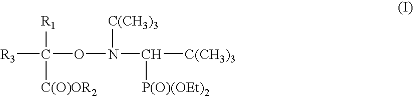

in which:
R₁ and R₃, which may be identical or different, represent a linear or branched alkyl group containing a number of carbon atoms ranging from 1 to 3;
R₂ represents a hydrogen atom, an alkali metal such as Li, Na or K, an ammonium ion such as NH₄₊, NBu₄⁺ or NHBu₃⁺, a linear or branched alkyl group containing a number of carbon atoms ranging from 1 to 8, or a phenyl group.

A particular example of a monoalkoxyamine is that corresponding to the formula below:

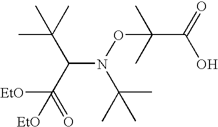

Alkoxyamines that may be advantageously used according to the invention may also be polyalkoxyamines derived from a method consisting in reacting one or more alkoxyamines of formula (I) below:

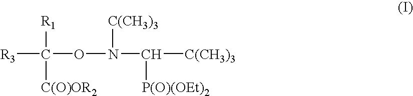

in which:
R₁ and R₃, which may be identical or different, represent a linear or branched alkyl group containing a number of carbon atoms ranging from 1 to 3;
R₂ represents a hydrogen atom, a linear or branched alkyl group containing a number of carbon atoms ranging from 1 to 8, a phenyl group, an alkali metal such as Li, Na or K, or an ammonium ion such as NH₄⁺ or NHBu₃⁺; R₁ preferably being CH₃ and R₂ preferably being H;
   with at least one polyunsaturated compound of formula (II):

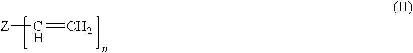

in which Z represents an aryl group or a group of formula Z₁—[X—C(O)]ₙ, in which Z₁ represents a polyfunctional structure originating for example from a compound of the polyol type, X is an oxygen atom, a nitrogen atom bearing a carbon-based group or an oxygen atom, or a sulfur atom, and n is an integer greater than or equal to 2,
in the presence or absence of solvent(s), preferably chosen from alcohols such as ethanol, aromatic solvents, chlorinated solvents, ethers and aprotic polar solvents,
at a temperature ranging, in general, from 0 to 90° C., preferably from 25 to 80° C.,
the molar ratio between monoalkoxyamine(s) of formula (I) and polyunsaturated compound(s) of formula (II) ranging from 1.5 to 1.5 n, preferably from n to 1.25 n,
this step being optionally followed by a step of evaporating the possible solvent(s).

The polyunsaturated compound of formula (II) can be chosen from polyfunctional vinylbenzenes (Z then being an aryl group) or from polyfunctional acrylic derivatives (Z then being a group of formula [Z₁—[X—C(O)]ₙ). Preferably, the polyunsaturated compound is divinylbenzene, trivinylbenzene, ethylene glycol diacrylate, 1,3-butanediol diacrylate, 1,4-butanediol diacrylate, 1,6-hexanediol diacrylate, neopentyl glycol diacrylate, cyclohexane dimethanol diacrylate, diethylene glycol diacrylate, triethylene glycol diacrylate, tetraethylene glycol diacrylate, dipropylene glycol diacrylate, tripropylene glycol diacrylate, polyethylene glycol diacrylates (sold by Sartomer under the names SR259, SR344, SR610), alkoxylated hexanediol diacrylates (sold by Sartomer under the names CD561, CD564, CD560), bisphenol-A diacrylate, ethoxylated bisphenol-A diacrylates (sold by Sartomer under the names SR349, SR601, SR602, CD9038), trimethylolpropane triacrylate, penta-erythrityl triacrylate, tris(2-hydroxyethyl) iso-cyanurate triacrylate, ethoxylated trimethylolpropane triacrylates (sold by Sartomer under the names SR454, SR499, SR502, SR9035, SR415), propoxylated glyceryl triacrylate (sold by Sartomer under the name SR9020), propoxylated trimethylolpropane triacrylates (sold by Sartomer under the names SR492 and CD501), pentaerythrityl tetraacrylate, ditrimethylolpropane tetraacrylate, ethoxylated pentaerythrityl tetra-acrylate (sold by Sartomer under the name SR494), dipentaerythrityl pentaacrylate, caprolactone modified dipentaerythrityl hexaacrylates (sold by Sartomer under the names Kayarad DCPA20 and DCPA60), and dipentaerythrityl polyacrylate (sold by UCB Chemicals under the name DPHPA).

The polyalkoxyamines thus produced correspond to formula (III) below:

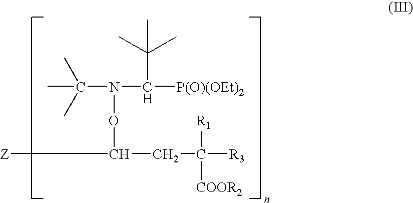

in which n, R₁, R₂, R₃ and Z have the same meanings as those given above.

A particular example of a polyalkoxyamine in accordance with the general definition given above is the polyalkoxyamine corresponding to the formula below:

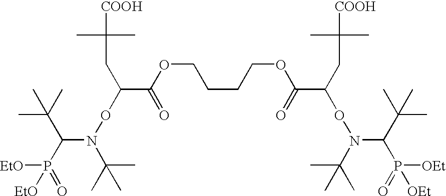

Without the applicant being held to any explanation, it thinks that, when the polymerization is carried out in an emulsion, the alkoxyamines of formula (I) and/or the polyalkoxyamines of formula (III) play both the role of initiating agent (and control agent) and the role of emulsifier; thus, the surfactant properties of the water-soluble alkoxyamines of formula (I) and/or polyalkoxyamines of formula (III) make it possible to moderate, or even to avoid, the use of other surfactants.

In particular, the alkoxyamines of formula (I) and/or the polyalkoxyamines of formula (III) are water-soluble.

For the purpose of the present invention, the term “water-soluble alkoxyamine” or “water-soluble poly-alkoxyamine” is intended to mean any alkoxyamine of formula (I) or polyalkoxyamine of formula (III) whose solubility in the water or (water/water-miscible compound) phase is at least 1 g/l at 25° C.

The alkoxyamine or polyalkoxyamine may be introduced into the polymerization medium (i.e. during each step a) or steps 1) and 4)) at a rate of 0.01% to 10%, preferably 0.1% to 5%, by mass relative to the mass of monomer(s).

The term “monomer” is intended to mean any free-radical-polymerizable or free-radical-copolymerizable monomer. The term monomer of course covers mixtures of several monomers.

The monomers used for producing the blocks may be chosen from monomers having a carbon-carbon double bond capable of free-radical polymerization, such as vinyl monomers, vinylidene monomers, diene monomers, olefin monomers, allyl monomers, acrylic monomers, methacrylic monomers, etc.

The monomers used may in particular be chosen from vinylaromatic monomers such as styrene or substituted styrene, in particular α-methylstyrene and sodium styrene sulfonate, dienes such as butadiene or isoprene, acrylic monomers such as acrylic acid or its salts, alkyl acrylates, cycloalkyl acrylates or aryl acrylates, such as methyl acrylate, ethyl acrylate, butyl acrylate, ethylhexyl acrylate or phenyl acrylate, hydroxyalkyl acrylates such as 2-hydroxyethyl acrylate, alkyl ether acrylates such as 2-methoxyethyl acrylate, alkoxy- or aryloxypolyalkylene glycol acrylates, such as methoxypolyethylene glycol acrylates, ethoxy-polyethylene glycol acrylates, methoxypolypropylene glycol acrylates, methoxypolyethylene glycol-polypropylene glycol acrylates, or mixtures thereof, aminoalkyl acrylates such as 2-(dimethylamino)ethyl acrylate (ADAME), acrylates of amine salts such as [2-(acryloyloxy)ethyl]trimethylammonium chloride, [2-(acryloyloxy)ethyl]trimethylammonium sulfate, [2-(acryloyloxy)ethyl]dimethylbenzylammonium chloride or [2-(acryloyloxy)ethyl]dimethylbenzylammonium sulfate, fluorinated acrylates, silylated acrylates, phosphorus-containing acrylates such as alkylene glycol phosphate acrylates, methacrylic monomers such as methacrylic acid or its salts, alkyl methacrylates, cycloalkyl methacrylates, alkenyl methacrylates or aryl methacrylates, such as methyl methacrylate, lauryl methacrylate, cyclohexyl methacrylate, allyl methacrylate or phenyl methacrylate, hydroxyalkyl methacrylates such as 2-hydroxyethyl methacrylate or 2-hydroxypropyl methacrylate, alkyl ether methacrylates such as 2-ethoxyethyl methacrylate, alkoxy- or aryloxy-polyalkylene glycol methacrylates, such as methoxypolyethylene glycol methacrylates, ethoxy-polyethylene glycol methacrylates, methoxypolypropylene glycol methacrylates, methoxypolyethylene glycol-polypropylene glycol methacrylates, or mixtures thereof, aminoalkyl methacrylates such as 2-(dimethylamino)ethyl methacrylate (MADAME), methacrylates of amine salts, such as [2-(methacryloyloxy)ethyl]trimethylammonium chloride, [2-(methacryloyloxy)ethyl]trimethylammonium sulfate or [2-(methacryloyloxy)ethyl]dimethylbenzylammonium chloride or [2-(methacryloyloxy)ethyl]-dimethylbenzylammonium sulfate, fluorinated methacrylates such as 2,2,2-trifluoroethyl methacrylate, silylated methacrylates such as 3-methacryloylpropyltrimethylsilane, phosphorus-containing methacrylates such as alkylene glycol phosphate methacrylates, hydroxyethylimidazolidone methacrylate, hydroxyethylimidazolidinone methacrylate, 2-(2-oxo-1-imidazolidinyl)ethyl methacrylate, acrylonitrile, acrylamide or substituted acrylamides, 4-acryloylmorpholine, N-methylolacrylamide, acrylamidopropyltrimethylammonium chloride (APTAC), acrylamidomethylpropanesulfonic acid (AMPS) or its salts, methacrylamide or substituted methacrylamides, N-methylol methacrylamide, methacrylamidopropyltrimethylammonium chloride (MAPTAC), itaconic acid, maleic acid or its salts, maleic anhydride, alkyl maleates or hemimaleates, alkoxy- or aryloxy-polyalkylene glycol maleates or hemimaleates, vinylpyridine, vinylpyrrolidinone, (alkoxy) poly(alkylene glycol) vinyl ether or (alkoxy) poly(alkylene glycol) divinyl ether, such as methoxy poly(ethylene glycol) vinyl ether, poly(ethylene glycol) divinyl ether, olefinic monomers, among which mention may be made of ethylene, butene, hexene and 1-octene, and also fluorinated olefinic monomers, and vinylidene monomers, among which mention may be made of vinylidene fluoride, alone or as a mixture of at least two abovementioned monomers.

It is possible to add to the polymerization medium for each step a) or for steps 1) and 4), when the polymerization is carried out in an emulsion, at least one emulsifier, i.e. a surfactant which makes it possible to stabilize the emulsion, it being understood that said emulsifier is not an alkoxyamine as described above. Any emulsifier that is common in this type of emulsion may be used.

The emulsifier may be anionic, cationic or nonionic. The emulsifier may be an amphoteric or quaternary or fluorinated surfactant

It may be chosen from alkyl sulfates, aryl sulfates, alkyl sulfonates, aryl sulfonates, fatty acid salts, polyvinyl alcohols and polyethoxylated fatty alcohols. By way of example, the emulsifier may be chosen from the following list:
sodium lauryl sulfate,
sodium dodecylbenzenesulfonate,
sodium stearate,
polyethoxylated nonylphenol,
sodium dihexyl sulfosuccinate,
sodium dioctyl sulfosuccinate,
lauryldimethylammonium bromide,
laurylamidobetaine,
potassium perfluorooctylacetate.

The emulsifier may also be an amphiphilic block or random or grafted copolymer, such as sodium styrene sulfonate copolymers, and in particular polystyrene-b-poly(sodium styrene sulfonate) or any amphiphilic copolymer prepared by any other polymerization technique.

The emulsifier may be introduced into the polymerization medium at a rate of 0.1% to 10% by mass relative to the mass of monomer(s).

The polymerization steps for producing the blocks (steps a) and steps 1 and 4) are carried out at a temperature suitable for the types of monomers that go to make up the block.

The polymerization temperatures depend on the monomers constituting the block. Thus, for initiating the polymerization of acrylate monomers from alkoxyamines as defined above, a temperature above 50° C., preferably below 130° C., more preferably ranging from 90° C. to 125° C., is advantageously chosen.

For initiating the polymerization of methacrylate monomers from alkoxyamines as defined above, a temperature above 50° C., preferably below 200° C., preferably ranging from 90° C. to 175° C., is advantageously chosen.

The blocks obtained in accordance with the method of the invention generally have a number-average molecular weight ranging from 1000 to 10⁶ g/mol and a polydispersity index of less than 2.

The degree of conversion of the monomers or mixture of monomers constituting the blocks generally depends on the time dedicated to producing the block and is generally fixed so as to obtain a block having a predetermined number-average molar mass.

According to the invention, between two steps for preparing two adjacent blocks (i.e. between two steps a) of two successive cycles or between steps 1) and 4)) and, optionally, after the step for preparing the last block (i.e. the end block) (corresponding to steps a) of two successive cycles or to step 5)), a step of polymerizing the monomer(s) that was (were) not converted and that constitute(s) the block which has just been synthesized is envisioned. This polymerization is carried out, for each step b) or for steps 2) and 5), generally by “conventional” free-radical polymerization, i.e. by addition, to the medium in which the block has just been produced, of a “conventional” free-radical polymerization initiator chosen generally from peroxide compounds (such as a peroxide compound of the Luperox™ range), persulfate compounds (such as sodium persulfate, potassium persulfate or ammonium persulfate), azo compounds (such as bisazidoisobutyronitrile, called AiBN, or 2,2′-azobis(2-amidinopropane) dihydrochloride and metal and ammoniacal salts of 4,4′-azobis(4-cyanopentanoic acid)), redox compounds (such as the pair sodium, potassium or ammonium persulfate/vitamin C, the pair sodium or potassium metabisulfite/persulfate, the pair aqueous hydrogen peroxide/ferrous ion salts, the pair tert-butyl hydroperoxide/sodium sulfoxylate and any other possible oxidizing agent(s)/reducing agent(s) combination). The polymerization temperature of this step (i.e. for each step b) or for steps 2) and 5)) is preferably chosen so as to be at least 20° C. below the polymerization temperature of the block which has just been polymerized (i.e. during steps a) or steps 1) and 4)). The decreasing of the temperature makes it possible to conserve the block previously synthesized in the form of a living polymer, without however continuing the polymerization thereof.

The polymer obtained at the end of the steps b) or of steps 2) and optionally 5) have a number-average molecular weight lower than that of the block synthesized just beforehand and, generally, also a polydispersity index greater than that of the block synthesized just beforehand. The condition with respect to the number-average molecular weight is essential for the final resulting material (polymer of blocks+polymers resulting from the polymerization of the monomers that were not converted, of each of the blocks) to be nanostructuring, these conditions making it possible for the polymers produced by conventional free-radical polymerization to remain compatible with the blocks of the block copolymer produced by controlled free-radical polymerization.

In order to facilitate the production of this condition with respect to the number-average molecular weight, it may be advantageous to add, for each step b) or for steps 2) and 5), a transfer agent (i.e. an agent capable of regulating the molecular weight of the polymer chains produced), it being possible for this transfer agent to be chosen from:
sulfur compounds, for example mercaptan compounds containing at least 4 carbon atoms, such as butane mercaptan, dodecyl mercaptan, tert-dodecyl mercaptan, disulfide compounds;
alcohol compounds, for example hindered phenols such as tert-butyl catechol, secondary alcohols such as isopropanol;
the transfer agents used for free-radical polymerization of the RAFT type, such as trithiocarbonates (in particular dibenzyl trithiocarbonate), xanthates, dithioesters or dithiocarbamates.

It may also be envisioned, in order for the polymers produced during these steps to have specific properties, to add, in addition to the polymerization initiator, monomers that are different than those of the monomers that were not converted.

Thus, the method of the invention makes it possible to obtain a polymeric material comprising a multiblock copolymer comprising n blocks connected to one another by covalent bonding, n being an integer greater than or equal to 2, and for at least each of the first (n−1) blocks, polymer chains formed by monomers that were not converted, that go to make up the corresponding block, said chains having a number-average molecular weight lower than that of the corresponding block and, generally, a polydispersity index greater than that of the corresponding block.

As mentioned above, this method is particularly suitable for the preparation of a polymeric material comprising an A-B diblock copolymer, such as an (n-butyl acrylate/methyl methacrylate) copolymer.

In this situation, as the method progresses, the following are respectively obtained for a polymeric material comprising at least one A-B diblock copolymer:
after the first step, a mixture comprising polymer chains that can be reinitiated, prefiguring block A of the block copolymer, and monomers that were not converted;
after the second step, a mixture comprising the polymer chains that can be reinitiated of the first step and polymer chains derived from the polymerization of the monomers that were not converted from the first step;
after the fourth step, a mixture comprising the diblock copolymer consisting of block A and of block B linked to one another by covalent bonding, polymer chains derived from the polymerization of the monomers that were not converted of the first step, monomers not converted during the fourth step;
after the fifth step, a mixture comprising the A-B diblock copolymer, polymer chains derived from the polymerization of the residual monomers of the first step and polymer chains derived from the polymerization of the monomers that were not converted during the fourth step.

Insofar as the number-average molecular weight of the polymer chains derived from the polymerization of the residual monomers of the first step is lower than that of block A, said chains are compatible with block A. Due to their number-average molecular weight, the chains derived from the fifth step are either compatible with block B, or it is block B which is compatible with these chains.

The method of the invention therefore produces a nanostructuring and nanostructured material.

The conditions for implementing the method for preparing a polymeric material comprising an A-B diblock copolymer are similar to those already described in the general section relating to the materials comprising a multiblock copolymer.

More specifically, the advantageous operating conditions and also the advantageous characteristics of the products derived from the first step (step 1)) may be the following:
a polymerization of the SFRP type for the synthesis of the first block preferably using as initiator alkoxyamines or polyalkoxyamines as defined above;
monomers used for the synthesis of the first block, chosen from acrylic and methacrylic derivatives, styrene derivatives as defined above;
a polymerization temperature above 50° C. and below 130° C., preferably ranging from 90° C. to 125° C.;
an achieved conversion preferably ranging from 60% to 95%, even more preferably ranging from 65% to 90%;
a number-average molecular weight of the first block preferably ranging from 5000 g/mol to 500 000 g/mol.

The advantageous operating conditions of the second step (step 2)) may be the following:
the use, for the polymerization of the monomers that were not converted, of conventional initiators chosen from azo derivatives such as bisazidoisobutyronitrile (AIBN), peroxides of the Luperox™ range, redox couples such as a Fenton system combining hydrogen peroxide with a metal (iron or copper) or such as the persulfate/-bisulfite couple;
a polymerization temperature ranging from 30° C. to 100° C., preferably from 50° C. to 80° C.;
the presence of transfer agents for regulating the molecular weight of the chains produced during this step, said agents being chosen preferably from mercaptan compounds containing at least 4 carbon atoms, such as butane mercaptan, dodecyl mercaptan, tert-dodecyl mercaptan, disulfides, hindered phenols such as tert-butyl catechol, secondary alcohols such as isopropanol, transfer agents of RAFT type such as trithiocarbonates (including in particular dibenzyltrithio-carbonate), xanthates, dithioesters and dithiocarbamates;
the addition of monomers other than the residual monomers in a proportion of from 0 to 10% of the monomers that were converted during this step, preferably from 0 to 5%, it being possible for these monomers to be chosen from acrylic acid, methacrylic acid and esters or amides thereof, such as in particular glycidyl esters, 2-ethanolamine esters, polyethylene glycol esters, 3-propenol esters or, in particular, dimethyl acrylamide. Other monomers, such as butadiene, maleic anhydride, vinyl acetate or monomers bearing halogen functions such as vinyl chloride, vinylidene chloride, vinylidene difluoride or vinyl tetrafluoride, may be copolymerized during this synthesis step.

The degree of conversion of the monomers that were not converted may range up to 100%, in a period of a few hours (for example, a period of 4 hours).

The advantageous operating conditions and also the advantageous characteristics of the products derived from the fourth step (step 4)) may be the following:
monomers used for the synthesis of the second block, chosen from acrylic and methacrylic derivatives, styrene derivatives as defined above;
a polymerization temperature above 50° C. and below 200° C., preferably ranging from 90° C. to 175° C.;
an achieved conversion preferably ranging from 45% to 95%, more preferably ranging from 50% to 90%.

The fifth step is carried out under conditions similar to those of the second step.

By way of example, a polymeric material prepared according to the invention is a material comprising a (poly(n-butyl acrylate)-b-poly(methyl methacrylate)) diblock copolymer.

The method of the invention may be applied to bulk polymerization, organic solvent (such as toluene) polymerization, emulsion polymerization or suspension polymerization methods. Each step of the method may be carried out in the same reactor via a “batch” method (or discontinuous method), or in different reactors optionally according to semi-continuous or continuous methods.

A subject of the invention is also a polymeric material that can be obtained by the method described above, comprising a multiblock copolymer comprising n blocks connected to one another by covalent bonding, n being an integer greater than or equal to 2, and for at least each of the first (n−1) blocks, preferably for each of the n blocks, polymer chains formed from the residual monomers that go to make up the corresponding block, said chains having a number-average molecular weight lower than that of the corresponding block and, generally, a polydispersity index greater than that of the corresponding block.

These materials benefit from the physicochemical properties associated with its nanostructuring, such as, for example, its transparency, its resistance to cracking or its ability to encapsulate other substances.

Thus, another subject of the invention is the use of the material as defined above as a thermoplastic.

By virtue of its transparency properties and its mechanical properties, such as an excellent shock value, the polymeric material according to the invention therefore finds its application in the luminaries field, the automobile field (for constituting, for example, headlights), the construction field, and domestic applications (for constituting, for example, spotlights in a display case). It may also find application in the cosmetics field. It may be specified that the materials of the invention find their application in all the known fields of application of poly(methyl methacrylate).

Another subject of the invention is the use of the material as defined above, as a nanostructuring additive for polymer matrices. Such matrices are, for example, thermoplastic polymers (polystyrene, poly(methyl methacrylate), polycarbonate, vinyl polychloride, vinylidene polychloride, polyamides, polypropylene, polyethylene, etc.), thermosetting polymers (polyepoxides, polyurethanes, unsaturated polyesters, etc.), crosslinked matrices (such as rubbers, polyethylenes, crosslinked styrene-butadiene resins) and blends thereof. The nanostructuring or nanostructured additives make it possible to confer on these matrices improved properties for use.

Finally, another subject of the invention is the use of the material as defined above, as a reinforcing and/or rheoplasticizer additive for polymer matrices. As an additive, it therefore finds its application in the aeronautics, electricity, electronics, thermostructural adhesives, sporting equipment and coatings field. Compared with pure block copolymers, the presence of this material having low-molecular-weight chains will induce better fluidity during the steps of converting these host matrices, such as injection and thermoforming, etc.

### BRIEF DESCRIPTION OF THE FIGURES

FIG. 1 represents a photograph obtained by atomic force microscopy of a material of example 3;

FIG. 2 represents a photograph obtained by atomic force microscopy of a material of example 4;

FIG. 3 represents a photograph obtained by atomic force microscopy of a material of example 6;

### DETAILED DISCLOSURE OF SPECIFIC EMBODIMENTS

For the implementation of the examples below, the following initiators of the alkoxyamine type were prepared beforehand:
the initiator and control agent of the monoalkoxyamine type of formula below:

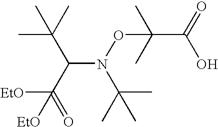

This initiator is prepared in the following way:

500 ml of degassed toluene, 35.9 g of CuBr (250 mmol), 15.9 g of powdered copper (250 mmol) and 86.7 g of N,N,N′,N′N″-pentamethyldiethylenetriamine, PMDETA (500 mmol) are introduced into a 2-liter glass reactor flushed with nitrogen, and then, with stirring and at ambient temperature (20° C.), a mixture containing 500 ml of degassed toluene, 42.1 g of 2-bromo-2-methyl-propionic acid (250 mmol) and 78.9 g of nitroxide of formula:

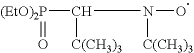

at 84%, i.e. 225 mmol, is introduced.

The mixture is left to react for 90 min at ambient temperature and with stirring, and then the reaction medium is filtered. The toluenic filtrate is washed twice with 1.5 l of a saturated aqueous solution of NH₄Cl.

A yellowish solid is obtained and is washed with pentane to give 51 g of 2-methyl-2-[N-tert-butyl-N-(diethoxyphosphoryl-2,2′-dimethylpropyl)aminoxy]-propionic acid (yield 60%).

The analytical results are given below:
molar mass determined by mass spectrometry: 381.44/g.mol⁻¹ (for C₁₇H₃₆NO₆P);
elemental analysis (empirical formula: C₁₇H₃₆NO₆P):
   % calculated: C=53.53, H=9.51, N=3.67;
   % found: C=53.57, H=9.28, N=3.77;
melting determined on a Büchi B-540 device: 124° C./125° C.;
the initiator and control agent of the dialkoxyamine type of formula below:

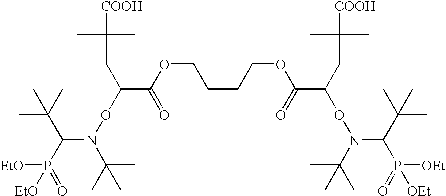

This initiator is prepared in accordance with the protocol described in FR 2861394.

The polymeric materials prepared according to the examples disclosed below are respectively analyzed by:
¹H NMR in deuterated chloroform on a Brucker 400 device;
DMA (abbreviation for dynamic mechanical analysis), which consists in measuring the viscoelastic properties G′, G″ and tan δ of a product as a function of the temperature at a stress frequency of 1 Hz, the quantities G′, G″ and tan δ corresponding respectively to the elastic or storage modulus (in Pa), to the viscous or lost modulus (in Pa) and to the ratio (G″/G′), these measurements being carried out on an Ares rheometer from Rheometrics Scientific and making it possible to obtain the glass transition temperature value for the material;
size exclusion chromatography carried out at 30° C. using a polystyrene standard as reference for measuring the number-average molecular weights.

### EXAMPLE 1

This example presents the preparation of a first living poly(n-butyl acrylate) block by a bulk method, which will be used for examples 2 to 5 which follow.

The protocol for preparing this first living block is the following:

12 kg of n-butyl acrylate and 150 g of the initiator of the monoalkoxyamine type defined above are introduced, at ambient temperature, into a 16-liter, jacketed, stainless steel reactor equipped with a decompression valve tared at 10 bar and a “double-propeller” stirrer. The mixture is degassed and maintained under a nitrogen atmosphere of 3 bar and then heated until the temperature of 118° C. is reached. The exothermy of the polymerization reaction is countered by virtue of a heat exchanger containing glycolated water at −25° C. The mixture is heated for 3 h 30, until the polymerization reaction is complete.

The mixture is then cooled to ambient temperature in 15 minutes, so as to quench the reaction mixture. A solution of polymer in n-butyl acrylate is recovered via a bottom valve.

Measurement of dry extract indicates that there has been a 60% conversion, i.e. 60% of the n-butyl acrylate present in the initial mixture has been polymerized.

The intermediate poly(n-butyl acrylate) is characterized by size exclusion chromatography, which gives the following data:
number-average molecular weight Mn=19 330 g/mol;
polydispersity index Ip=1.35.

This polymer solution is used as it is for examples 2 to 5.

### EXAMPLE 2

This example illustrates the preparation of a diblock copolymer by controlled free-radical polymerization, by means of a method carried out by bulk/organic solvent polymerization in accordance with the prior art.

The preparation protocol is the following:

After cleaning with toluene, the same reactor as in example 1 is loaded with 2.5 kg of the solution obtained in example 1 and 4 kg of methyl methacrylate, the initial mixture thus comprising 1.5 kg of living poly(n-butyl)acrylate, 1 kg of residual n-butyl acrylate and 4 kg of methyl methacrylate. The whole is diluted with 2.5 kg of toluene.

After placing under nitrogen, the reactor is heated up to 105° C. for one hour and then 120° C. for one hour, before being cooled in 15 minutes to ambient temperature.

The dry extract has a value of 55%, which corresponds to a monomer (methyl methacrylate+residual n-butyl acrylate) conversion of 70%.

The diblock copolymer obtained has the following characteristics:
number-average molecular weight Mn=65 000 g/mol;
polydispersity index Ip=2.1.

The chemical composition of the copolymer is determined by ¹H NMR and gives the following results:
poly(methyl methacrylate): 55% (by weight);
poly(n-butyl acrylate): 45% (by weight).

It also follows from this analysis that the poly(methyl methacrylate) block comprises 16% by weight of n-butyl acrylate.

Such a copolymer is nanostructured, but the DMA analysis shows that the glass transition temperature of the second block is 95° C., which is 15° C. below what is obtained for a pure poly(methyl methacrylate). The copolymer of the example cannot therefore be used in an application requiring heat stability above 80° C.

### EXAMPLE 3

This example illustrates the preparation of a polymeric material comprising a diblock copolymer by controlled free-radical polymerization, by means of a method carried out by bulk/solvent polymerization according to conditions not in accordance with the invention.

The preparation protocol is the following:

1 kg of the solution obtained in example 1 is diluted with 500 g of toluene and then introduced into a 5-liter, jacketed, stainless steel reactor equipped with a decompression valve tared at 10 bar and an “anchor” stirrer.

1 g of AiBN (bis(azo-isobutyronitrile)) is added at ambient temperature. The mixture is degassed, placed under nitrogen, stirred and then heated to 85° C. The temperature is maintained below 95° C. for 2 hours.

The final mixture has a dry extract of 65%, i.e. an 86% conversion of the residual n-butyl acrylate.

Over these two steps, 94.5% of acrylate was converted.

The gas chromatography analysis indicates a number-average molecular weight Mn of 28 500 and a polydispersity index Ip of 6.

3 kg of methyl methacrylate are added to this same reactor. The mixture is degassed and then heated at 105° C. for one hour and then 120° C. for another hour.

The final conversion is 50% of the methyl methacrylate.

The composition of the product is the following:
60% of poly(methyl methacrylate);
40% of poly(n-butyl acrylate), including 24% linked to the poly(methyl methacrylate) block and 16% of poly(n-butyl acrylate) not linked to the block.

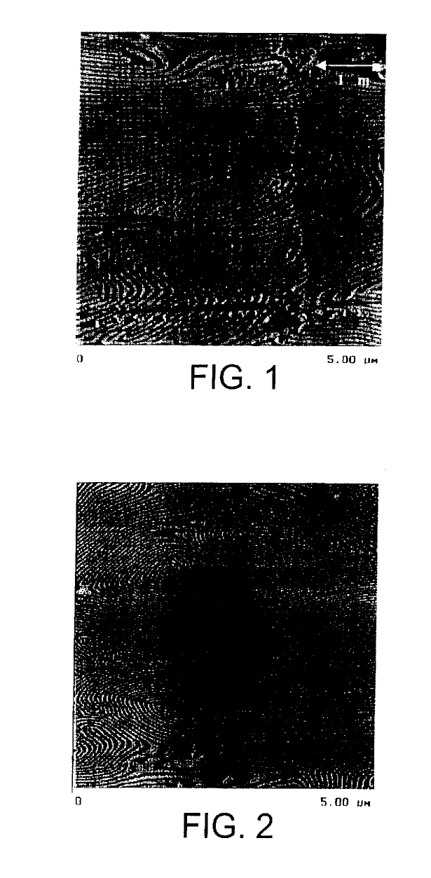

The highest Tg of the product analyzed by DMA is 110° C., which is a Tg in accordance with the invention. However, it is observed by atomic force microscopy that n-butyl acrylate agglomerates in nodules of the order of several hundred nanometers, which shows that some of the free chains generated during the second step are not soluble in the network, which is moreover nanostructured, of the block copolymer. This organization explains the slight cloud observed in the material in FIG. 1.

### EXAMPLE 4

This example illustrates the preparation of a polymeric material comprising a diblock copolymer by controlled free-radical polymerization in solution according to the conditions of the invention.

1) Production of the poly(n-butyl acrylate) Block

1 kg of the solution obtained in example 1 is introduced into a 5-liter, jacketed, stainless steel reactor equipped with a decompression valve tared at 10 bar and an “anchor” stirrer.

1 g of AiBN (bis(azoisobutyronitrile)) and 1.2 g of dodecyl mercaptan are added at ambient temperature. The mixture is degassed, placed under nitrogen, stirred and then heated to 85° C. The temperature is maintained below 95° C. for one 1 hour. The final mixture has a dry extract of 97.5%.

The gas chromatography analysis gives the following data:
number-average molecular weight Mn=17 500; polydispersity index Ip=1.8.

### 2) Production of the Diblock Copolymer in Solution

3 kg of methyl methacrylate and 500 g of toluene are added to the same reactor. The mixture is degassed and stirred for one hour at ambient temperature, so as to be completely homogeneous, and is then heated at 105° C. for one hour and then 120° C. for another hour.

The final conversion is 55% of the methyl methacrylate. The composition of the material in solution is the following:
62% of poly(methyl methacrylate);
38% of poly(n-butyl acrylate), including 22.8% of poly(butyl acrylate) linked to the poly(methyl methacrylate) block and 15.2% of poly(n-butyl acrylate) not linked to the block.

The highest Tg of the product analyzed by DMA is 110° C., which is in accordance with the invention. It is observed by atomic force microscopy that, over scales of several microns, the product is indeed nanostructured. The poly(n-butyl acrylate) produced in the presence of transfer agent is completely soluble in the nanodomains of the block copolymer (cf. FIG. 2). As expected, the product obtained is indeed transparent.

### 3) Continuous Bulk Production of a Material Having Good Mechanical Properties

5 kg of product obtained as in step 1) are mixed with 30 kg of methyl methacrylate. This mixture is introduced into a storage tank cooled to −23° C.

The solution is injected, at a flow rate of 2 kg/h, into a 5-liter reactor heated to 155° C. and equipped with a continuous extraction system feeding an extruding-degassing device through transfer pipes heated to 90° C. The extraction flow rate corresponds to the introduction flow rate.

The flow rate is maintained at this rate until the amount of solid inside the reactor reaches a value of between 50% and 55%. At this point, the flow rate is adjusted such that the temperature in the reactor is 163° C.±5° C. (the acceleration in flow rate serves to reduce the temperature, slowing of the flow rate increases it).

After degassing, transparent granules indicative of nanostructuring are recovered (the transparency index is 98%).

The upper Tg of the product analyzed by DMA is 108° C., which is in accordance with the invention.

The mechanical tests on the material show a toughness, in a non-notched impact test, of 82 kJ/m², and a module of 1680 MPa, which are comparable to the values found in the same tests for commercially available impact-reinforced grades of poly(methyl methacrylate).

### EXAMPLE 5

This example illustrates the preparation of a polymeric material comprising a diblock copolymer by controlled free-radical emulsion polymerization according to the conditions of the invention.

a) Emulsion-Preparation of the Living Difunctionalized poly(n-butyl acrylate) Block

The preparation of the living difunctionalized poly(n-butyl acrylate) block by controlled free-radical emulsion polymerization is carried out in two steps.

First Step: Preparation of a Seed with a Low Level of Solids (Approximately 1% by Weight)

6.6 g (i.e. 0.05 mol) of n-butyl acrylate, 500 g of distilled water, 3.3 g (4.01 mmol) of Dowfax 8390 emulsifier, 0.55 g (6.55 mmol) of NaHCO₃ and 2.3 g (2.39 mmol) of dialkoxyamine of formula given above, prepared in accordance with what is described in FR 2861394, neutralized with an excess of sodium hydroxide (1.7 equivalents per acid function present in the dialkoxyamine, i.e. 0.326 g of NaOH), are introduced into 2-liter reactor equipped with a variable speed motorized stirrer, with inlets for the introduction of reactants, with branched connections for the introduction of inert gases which make it possible to drive off the oxygen, such as nitrogen, with measuring probes (e.g. for measuring temperature), of a system for condensing vapors with reflux, and with a jacket which makes it possible to heat/cool the content of the reactor by virtue of the circulation in the jacket of a heat-transfer fluid. The reaction mixture is then degassed several times with nitrogen, and then brought to 120° C., and this temperature is maintained by heat regulation for 8 hours.

Second Step: Addition of the N-butyl acrylate.

143.4 g (1.12 mol) of n-butyl acrylate are introduced, in a single portion, into the seed prepared in the first step. The reaction medium is then degassed several times with nitrogen, stirred at ambient temperature for 30 minutes, and then brought to 120° C. This temperature is maintained by heat regulation for approximately 1 h 30, until the n-butyl acrylate conversion reaches 80%.

Samples of the reaction medium are taken every hour in order to determine the polymerization kinetics by gravimetry (measurement of dry extracts).

The level of solids in the difunctionalized poly(n-butyl acrylate) latex obtained is approximately 18%.

The conversion of the n-butyl acrylate is evaluated at 80% by weight by gravimetry.

The molecular weights of the difunctionalized poly(n-butyl acrylate) obtained by controlled free-radical polymerization, in polystyrene equivalents, are the following:
Peak molecular weight at the peak Mp=50 000 g/mol;
Number-average molecular weight Mn=45 000 g/mol;
Weight-average molecular weight Mw=68 000 g/mol;
Polydispersity index Ip=1.5.
   b) Curing of the Residual N-butyl acrylate in Emulsion

A solution containing 0.225 g (0.83 mmol) of ammonium persulfate, 0.219 g (1.42 mmol) of sodium formaldehyde sulfoxylate and 0.045 g (0.22 mmol) of tert-dodecyl mercaptan transfer agent in 5 ml of distilled water is then added, in a single portion, to the previously prepared poly(n-butyl acrylate) latex in order to convert the 20% of residual n-butyl acrylate. The reaction medium is degassed, and then heated to 60° C. (temperature below the dissociation temperature of the difunctionalized poly(n-butyl acrylate)) for 4 hours.

The level of solids in the poly(n-butyl acrylate) latex obtained is 22%.

The conversion of the n-butyl acrylate is then evaluated at 98% by weight by gravimetry. The molecular weights of the poly(n-butyl acrylate) obtained by controlled free-radical polymerization and conventional free-radical polymerization, in polystyrene equivalents, are the following:
Peak molecular weight Mp=46 000 g/mol;
Number-average molecular weight Mn=36 000 g/mol;
Weight-average molecular weight Mw=72 500 g/mol;
Polydispersity index Ip=2.
   c) Reinitiation of the Difunctionalized poly(N-butyl acrylate) Block with methyl methacrylate

6.2 g (7.54 mmol) of Dowfax 8390 emulsifier, 490 g of distilled water and 0.54 g (6.43 mmol) of NaHCO₃ are added at ambient temperature to the preceding latex (containing the difunctionalized poly(n-butyl acrylate) and the poly(n-butyl acrylate) derived from the conventional free-radical polymerization method). After degassing with nitrogen, the reaction medium is brought to 105° C. and, when the temperature reaches 105° C., 280 g (2.80 mol) of methyl methacrylate are then added continuously over a period of 3 hours. The temperature is then maintained at 105° C. for a further three hours and the reaction medium is then cooled to ambient temperature. The conversion of the methyl methacrylate is evaluated by measurement of dry extract at 35%.

The level of solids in the latex is 17%. The residual methyl methacrylate is then converted by a conventional free-radical polymerization method as described in the step below.

d) Curing of the Residual methyl methacrylate by a Conventional Free-Radical Emulsion Polymerization Method

After cooling of the preceding latex, a solution containing 0.364 g (1.35 mmol) of potassium persulfate in 5 ml of distilled water is introduced at ambient temperature. The reaction medium is degassed with nitrogen and then brought to 75° C. and maintained at this temperature for 4 hours. The conversion of the methyl methacrylate is then evaluated at 98% by measurement of dry extract.

The level of solids in the latex obtained is 30%.

### EXAMPLE 6

The product obtained in example 5 is dissolved in a proportion of 10% by mass in a mixture, at a temperature of 95° C., of DGEBA/MDEA, having the following respective formulae:

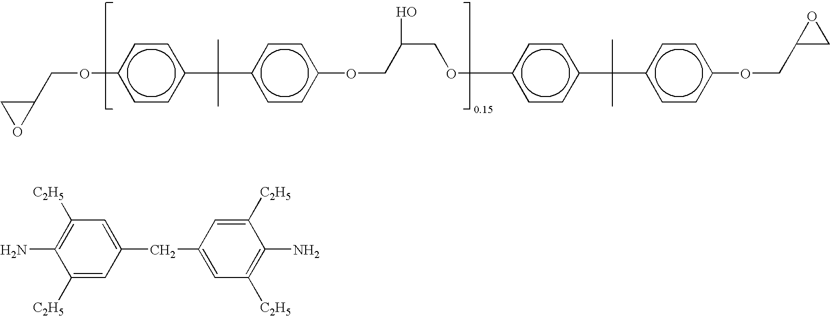

After degassing, the crosslinking reaction is initiated at 135° C. and the curing is pursued for 2 hours.

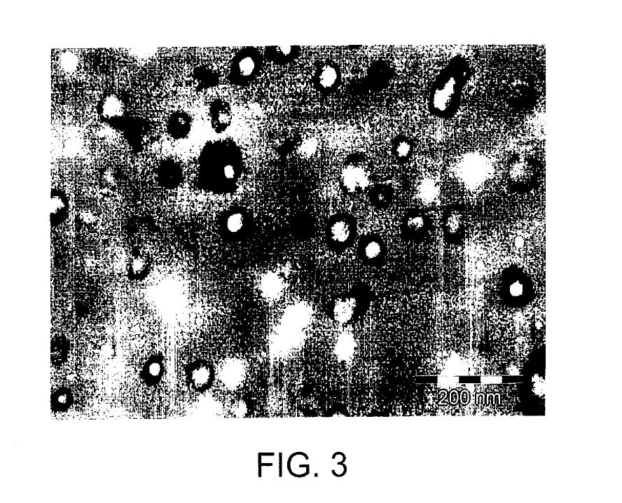

After curing, the thermoset material is transparent. The analysis by transmission electron microscopy reveals that this material is nanostructured. The copolymer is dispersed in the form of light microparticles surrounded by a dark crown of uneven thickness, of variable shape and of variable sizes. These domains are of the order of 10 nm. The core corresponds to the poly(butyl acrylate), the shell represents the domains of poly(butyl methacrylate), which have good affinity with the epoxy matrix (cf. FIG. 3).

1. A method for preparing a polymeric material comprising a multiblock copolymer comprising n blocks, where n is an integer greater than or equal to 2, said method comprising at least one cycle of steps comprising:
a) a step of synthesizing a block by controlled free-radical polymerization of one or more free-radical-polymerizable monomers; and
b) a step of polymerizing monomers that were not converted during step a) into a polymer having a number-average molecular weight lower than the number-average molecular weight of said block;
wherein said cycle of steps is carried out at least for the first n−1 blocks.

2. The method as claimed in claim 1, in which the cycle of steps is carried out for the n blocks.

3. A method for preparing a polymeric material comprising a copolymer comprising at least one block A and at least one block B, said method comprising successively:
a) a step of polymerizing one or more free-radical-polymerizable monomers by controlled free-radical polymerization, so as to form block A;
b) a step of polymerizing the monomers that were not converted during step a), so as to form a polymer of chemical nature identical to block A but having a number-average molecular weight lower than that of block A;
c) a step of adding to the medium resulting from steps a) and b) one or more free-radical-polymerizable monomers that are precursors of block B;
d) a step of polymerizing said monomers that are precursors of block B by controlled free-radical polymerization, said block B being linked to block A by covalent bonding; and
e) optionally, a step of polymerizing the monomers that were not converted during step d), so as to form a polymer of chemical nature identical to block B but having a number-average molecular weight lower than that of block B.

4. The method as claimed in claim 1, carried out in emulsion, in bulk or in an organic solvent.

5. The method as claimed in claim 1, in which step a) is carried out by stable free-radical polymerization.

6. The method as claimed in claim 5, in which the stable free-radical polymerization is carried out in the presence of at least one alkoxyamine chosen from the monoalkoxyamines of formula (I): 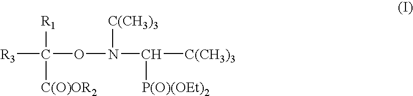
in which:
R₁ and R₃, which may be identical or different, represent a linear or branched alkyl group containing a number of carbon atoms ranging from 1 to 3;
R₂ represents a hydrogen atom, an alkali metal, an ammoniumion, a linear or branched alkyl group containing a number of carbon atoms ranging from 1 to 8, or a phenyl group.

7. The method as claimed in claim 6, in which the alkoxyamine corresponds to the formula below:

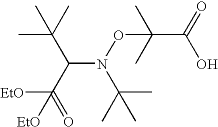

8. The method as claimed in claim 5, in which the stable free-radical polymerization is carried out in the presence of at least one polyalkoxyamine derived from a method consisting in reacting one or more alkoxyamines of formula (I) below: 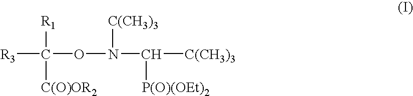
in which:
R₁ and R₃, which may be identical or different, representing a linear or branched alkyl group containing a number of carbon atoms ranging from 1 to 3;
R₂ representing a hydrogen atom, a linear or branched alkyl group containing a number of carbon atoms ranging from 1 to 8, a phenyl group, an alkali metal, or an ammonium ion;
with at least one polyunsaturated compound of formula (II): 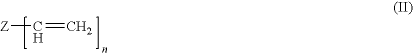
in which Z represents an aryl group or a group of formula Z₁—[X—C(O)]ₙ, in which Z₁ represents a polyfunctional structure, X is an oxygen atom, a nitrogen atom bearing a carbon-based group or an oxygen atom, or a sulfur atom, and n is an integer greater than or equal to 2, in the presence or absence of solvent(s),
at a temperature ranging, from 0 to 90° C.,
the molar ratio between monoalkoxyamines of formula (I) and polyunsaturated compounds of formula II ranging from 1.5 to 1.5 n;
this step being optionally followed by a step of evaporating the possible solvents.

9. The method as claimed in claim 8, in which the polyalkoxyamine corresponds to the formula below:

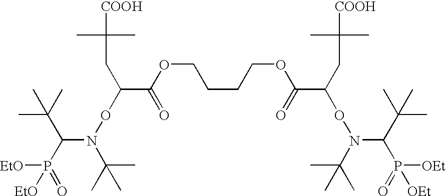

10. The method as claimed in claim 6, in which the alkoxyamine is introduced into the polymerization medium in a proportion of 0.01% to 10% by mass relative to the mass of monomers.

11. The method as claimed in claim 1, in which the free-radical-polymerizable monomers are chosen from monomers having a carbon-carbon double bond capable of free-radical polymerization.

12. The method as claimed in claim 11, in which the monomers having a carbon-carbon double bond capable of free-radical polymerization are chosen from vinylaromatic monomers, dienes, acrylic monomers, alkyl acrylates, cycloalkyl acrylates or aryl acrylates, hydroxyalkyl acrylates, alkyl ether acrylates, alkoxy- or aryloxy-polyalkylene glycol acrylates, ethoxypolyethylene glycol acrylates, methoxypolypropylene glycol acrylates, methoxypolyethylene glycol-polypropylene glycol acrylates, or mixtures thereof, aminoalkyl acrylates, acrylates of amine salts, fluorinated acrylates, silylated acrylates, phosphorus-containing acrylates, methacrylic monomers, alkyl methacrylates, cycloalkyl methacrylates, alkenyl methacrylates, aryl methacrylates, hydroxyalkyl methacrylates, alkyl ether methacrylates, alkoxy- or aryloxy-polyalkylene glycol methacrylates, aminoalkyl methacrylates, methacrylates of amine salts, fluorinated methacrylates, silylated methacrylates, phosphorus-containing methacrylates, hydroxyethylimidazolidone methacrylate, hydroxyethylimidazolidinone methacrylate, 2-(2-oxo-1-imidazolidinyl)ethyl methacrylate, acrylonitrile, acrylamide or substituted acrylamides, 4-acryloylmorpholine, N-methylolacrylamide, acrylamidopropyltrimethylammonium chloride (APTAC), acrylamidomethylpropanesulfonic acid (AMPS) or its salts, methacrylamide or substituted methacrylamides, N-methylol methacrylamide, methacrylamidopropyltrimethylammonium chloride (MAPTAC), itaconic acid, maleic acid or its salts, maleic anhydride, alkyl maleates or hemimaleates, alkoxy- or aryloxy-polyalkylene glycol maleates or hemimaleates, vinylpyridine, vinylpyrrolidinone, (alkoxy) poly(alkylene glycol) vinyl ether or (alkoxy) poly(alkylene glycol) divinyl ether, poly(ethylene glycol) divinyl ether, olefinic monomers, fluorinated olefinic monomers, and vinylidene monomers, alone or as a mixture of at least two abovementioned monomers.

13. The method as claimed in claim 1, in which step a) is, when the method is carried out in emulsion, carried out in the presence of at least one anionic, cationic or nonionic emulsifier.

14. The method as claimed in claim 13, in which the emulsifier is chosen from alkyl sulfates, aryl sulfates, alkyl sulfonates, aryl sulfonates, fatty acid salts, polyvinyl alcohols or polyethoxylated fatty alcohols.

15. The method as claimed in claim 1, in which each step b) is carried out in the presence of a free-radical polymerization initiator chosen from peroxide compounds, persulfate compounds, azo compounds or redox compounds.

16. The method as claimed in claim 1, in which step b) is carried out at a polymerization temperature at least 20° C. below that of each step a).

17. The method as claimed in claim 1, in which each step b) is carried out in the presence of at least one transfer agent chosen from sulfur compounds, alcohol compounds, or transfer agents used for free-radical polymerization of the reversible addition fragmentation transfer type.

18. The method as claimed in claim 17, in which the sulfur compounds are chosen from mercaptan compounds containing at least 4 carbon atoms and disulfide compounds.

19. The method as claimed in claim 17, in which the alcohol compounds are chosen from hindered phenols and secondary alcohols.

20. The method as claimed in claim 17, in which the transfer agents used for the free-radical polymerization of the reversible addition fragmentation transfer type are chosen from trithiocarbonates, xanthates, dithioesters and dithiocarbamates.

21. The method as claimed in claim 1, in which the polymeric material is a material comprising a diblock copolymer.

22. The method as claimed in claim 21, in which the diblock copolymer is a (poly(n-butyl acrylate)-b-poly(methyl methacrylate)) copolymer.

23. A polymeric material obtained by a method as defined in claim 1, comprising a multiblock copolymer comprising n blocks connected to one another by covalent bonding, n being an integer greater than or equal to 2, and for at least each of the first (n−1) blocks, polymer chains formed from the residual monomers that go to make up the corresponding block, said chains having a number-average molecular weight lower than that of the corresponding block.

24. The polymeric material as claimed in claim 23, comprising polymer chains formed from the residual monomers that go to make up the corresponding block, said chains having a number-average molecular weight lower than that of the corresponding block for each of the n blocks.

25. The use of a material as defined in claim 23, as a thermoplastic.

26-29. (canceled)

30. The method as claimed in claim 3, carried out in emulsion, in bulk or in an organic solvent.

31. The method as claimed in claim 3, in which each step a) and b) is carried out by stable free-radical polymerization.

32. The method as claimed in claim 3, in which each step a) and b) are, when the method is carried out in emulsion, carried out in the presence of at least one anionic, cationic or nonionic emulsifier.

33. The method as claimed in claim 3, in which each step b) and e) are carried out in the presence of a free-radical polymerization initiator chosen from peroxide compounds, persulfate compounds, azo compounds or redox compounds.

34. The method as claimed in claim 3, in which each step b) and e) are carried out at a polymerization temperature at least 20° C. below that of each of steps a) and d).

35. The method as claimed in claim 3, in which each step b) and e) are carried out in the presence of at least one transfer agent chosen from sulfur compounds, alcohol compounds, or the transfer agents used for free-radical polymerization of the reversible addition fragmentation transfer type.

36. The method as claimed in claim 35, in which the sulfur compounds are chosen from mercaptan compounds containing at least 4 carbon atoms and disulfide compounds.

37. The method as claimed in claim 35, in which the alcohol compounds are chosen from hindered phenols and secondary alcohols.

38. The method as claimed in claim 35, in which the transfer agents used for the free-radical polymerization of the reversible addition fragmentation transfer type are chosen from trithiocarbonates, xanthates, dithioesters and dithiocarbamates.

39. The method as claimed in claim 3, in which the polymeric material is a material comprising a diblock copolymer.

40. The method as claimed in claim 39, in which the diblock copolymer is a (poly(n-butyl acrylate)-b-poly(methyl methacrylate)) copolymer.

41. A polymeric material obtained by a method as defined in claim 3, comprising a multiblock copolymer comprising n blocks connected to one another by covalent bonding, n being an integer greater than or equal to 2, and for at least each of the first (n−1) blocks, polymer chains formed from the residual monomers that go to make up the corresponding block, said chains having a number-average molecular weight lower than that of the corresponding block.

42. The polymeric material as claimed in claim 41, comprising polymer chains formed from the residual monomers that go to make up the corresponding block, said chains having a number-average molecular weight lower than that of the corresponding block for each of the n blocks.
